(19) United States
(12) Patent Application Publication
(10) Pub. No.: US 2015/0234213 A1
(43) Pub. Date: Aug. 20, 2015

(54) TOUCH DISPLAY

(71) Applicant: HengHao Technologies Co. Ltd, Hsinchu County (TW)

(72) Inventors: CHING-FANG WONG, Taoyuan County (TW); CHIA-TIEN LIU, Taoyuan County (TW); PAO-WEN CHEN, Taoyuan County (TW)

(21) Appl. No.: 14/311,162

(22) Filed: Jun. 20, 2014

(30) Foreign Application Priority Data
Feb. 20, 2014 (TW) 103105581

(51) Int. Cl. G02F 1/1333

(52) U.S. Cl. CPC G02F 1/1333; G02F 1/13338

(57) ABSTRACT

A touch display includes a first sealant, a surface adhesive and a second sealant disposed between a display panel and a touch panel. The first sealant is disposed on periphery of the touch display; the surface adhesive fills a space defined by the first sealant; and the second sealant is disposed outside of and surrounding the space defined by the first sealant.

### CLAIM OF PRIORITY

The present application claims priority from Taiwan Application No. 103105581, filed on Feb. 20, 2014 and entitled “TOUCH DISPLAY,” the contents of which are expressly incorporated herein by reference in their entirety.

1. Background of the Disclosure

The present invention generally relates to a touch display, and more particularly to a touch display with high bonding strength.

2. Description of Related Art

Touch screens, as input/output devices that adopt sensing technology and display technology, have been widely employed in electronic devices such as portable or hand-held electronic devices.

FIG. 1 shows a lateral view of a conventional touch display 100, which may primarily include a liquid crystal display panel 11 and a touch panel 12. In order to obtain good visual perception, the liquid crystal display panel 11 and the touch panel 12 are bonded together by an optically-clear adhesive (OCA) 13.

During the process of manufacturing the touch display 100, however, faulty products may occur when there is defective bonding, thereby reducing yield. Faulty products from defective bonding typically need be reworked, resulting in material loss and waste. Moreover, the touch display 100 according to the bonding architecture of FIG. 1 may have a weak bonding strength, which may reduce a product lifetime of the touch display 100.

A need has thus arisen to propose a novel bonding structure, according to which disadvantages of the conventional touch display 100 may be reduced.

### SUMMARY OF THE INVENTION

In view of the foregoing, it is an object of the embodiments of the present invention to provide a touch display which has an enhanced bonding strength and good light-transmittance, and has an improved yield and product lifetime.

According to one embodiment, a touch display includes a display panel, a touch panel, a first sealant, a surface adhesive and a second sealant. The touch panel is disposed above the display panel. The first sealant is disposed between the display panel and the touch panel, and is disposed on a periphery of the touch display. The surface adhesive is disposed between the display panel and the touch panel, and fills a space defined by the first sealant. The second sealant is disposed between the display panel and the touch panel, and surrounds the space defined by the first sealant.

### BRIEF DESCRIPTION OF THE DRAWINGS

FIG. 1 shows a lateral view of a conventional touch display;

FIG. 2A shows a lateral view of a touch display according to a first embodiment of the present invention;

FIG. 2B shows a top view of the touch display of FIG. 2A;

FIG. 3 shows a lateral view of a touch display according to a modified embodiment of the present invention;

FIG. 4 shows a top view of a touch display according to a second embodiment of the present invention;

FIG. 5A shows a top view of a touch display according to a third embodiment of the present invention; and

FIG. 5B shows a top view of a touch display according to another modified embodiment of the present invention.

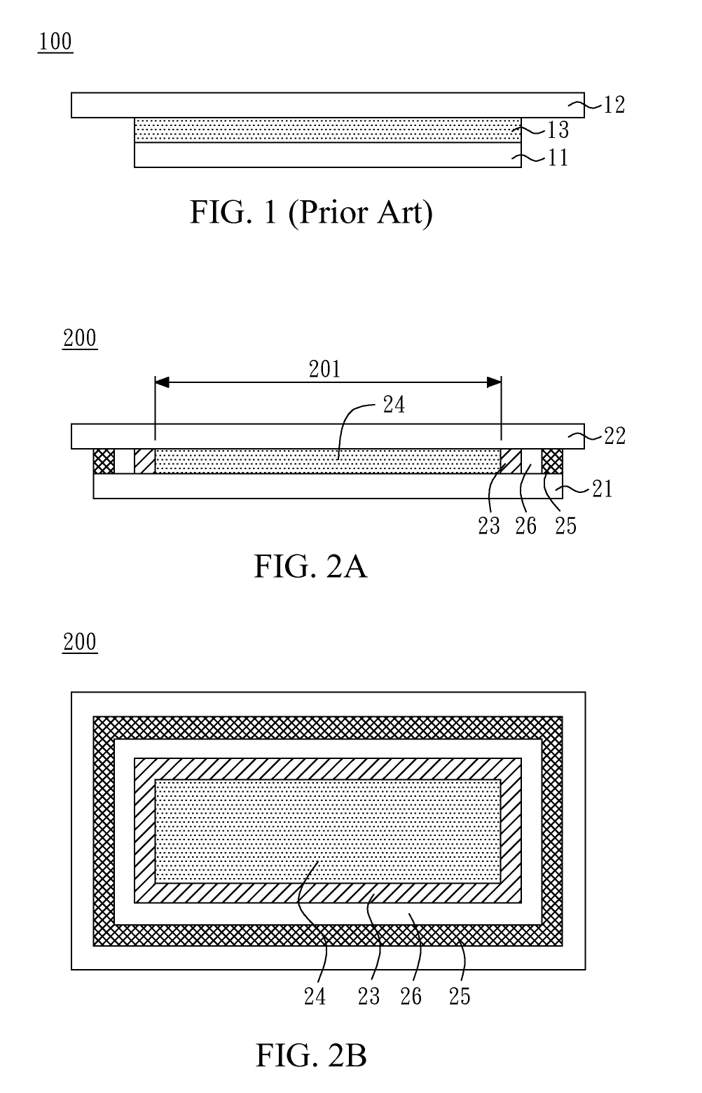

### DETAILED DESCRIPTION OF THE INVENTION

FIG. 2A shows a lateral view of a touch display 200 according to a first embodiment of the present invention, and FIG. 2B shows a top view of the touch display 200 of FIG. 2A. In the specification, a direction “above” points to a touch position, and a direction “below” points against the touch position.

In the embodiment, the touch display 200 includes a display panel 21 (e.g., a liquid crystal display panel) and a touch panel 22. The touch panel 22 is disposed above the display panel 21. A first sealant 23 is disposed between the display panel 21 and the touch panel 22, and is disposed on a periphery of, e.g. around or surrounding, an active area 201 of the touch display 200. The first sealant 23 may have a frame shape, which may be closed as shown in FIG. 2B or open.

A surface adhesive 24 is disposed between the display panel 21 and the touch panel 22, and fills a space defined by the first sealant 23. In one embodiment, at least one post (not shown), sustained between the display panel 21 and the touch panel 22, may be disposed within the space defined by the first sealant 23.

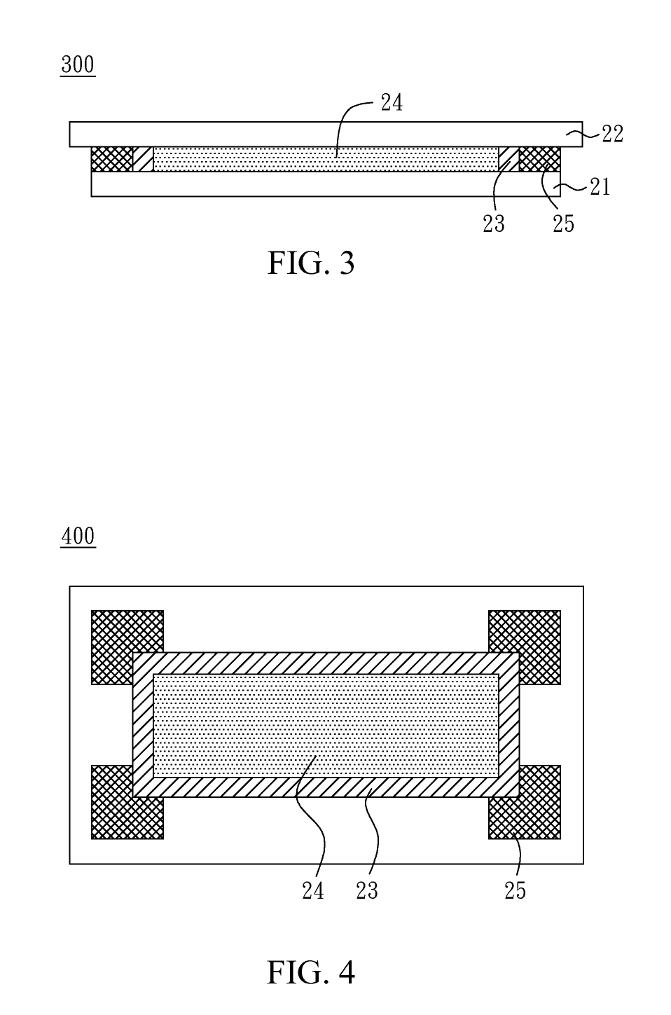

According to one aspect of the embodiment, a second sealant 25 is disposed outside of, e.g., around or surrounding, the space defined by the first sealant 23. The second sealant 25 may have a frame shape, which may be closed as shown in FIG. 2B. A gap 26 may exist between the first sealant 23 and the second sealant 25. FIG. 3 shows a lateral view of a touch display 300 according to a modified embodiment of the present invention. As distinct from FIG. 2A, there is no gap between the first sealant 23 and the second sealant 25. The second sealant 25 may be referred to as a reinforcement sealant, as it acts to reinforce the first sealant 23.

The first sealant 23, the surface adhesive 24 and the second sealant 25 may be made of conventional optically-clear adhesive (OCA), which may be liquid or solid when being coated on or adhered with adherend. In an embodiment, one or more of the first sealant 23, the surface adhesive 24 and the second sealant 25 may be made of a pressure-sensitive adhesive (PSA), which forms a bond with the display panel 21 and the touch panel 22. For instance, bonding may occur when pressure is applied from the display panel 21 and the touch panel 22. In another embodiment, one or more of the first sealant 23, the surface adhesive 24 and the second sealant 25 may be made of ultra-violet curing adhesive, which forms a bond with the display panel 21 and the touch panel 22. For instance, bonding may occur when the ultra-violet curing adhesive is illuminated with ultra-violet light.

FIG. 4 shows a top view of a touch display 400 according to a second embodiment of the present invention. In the embodiment, the second sealant 25 has an open frame shape, which includes four L-shape adhesives disposed around and external to four corners of a frame defined by the first sealant 23. There is no gap between the first sealant 23 and the second sealant 25. In other embodiments, a gap may exist between the first sealant 23 and the second sealant 25.

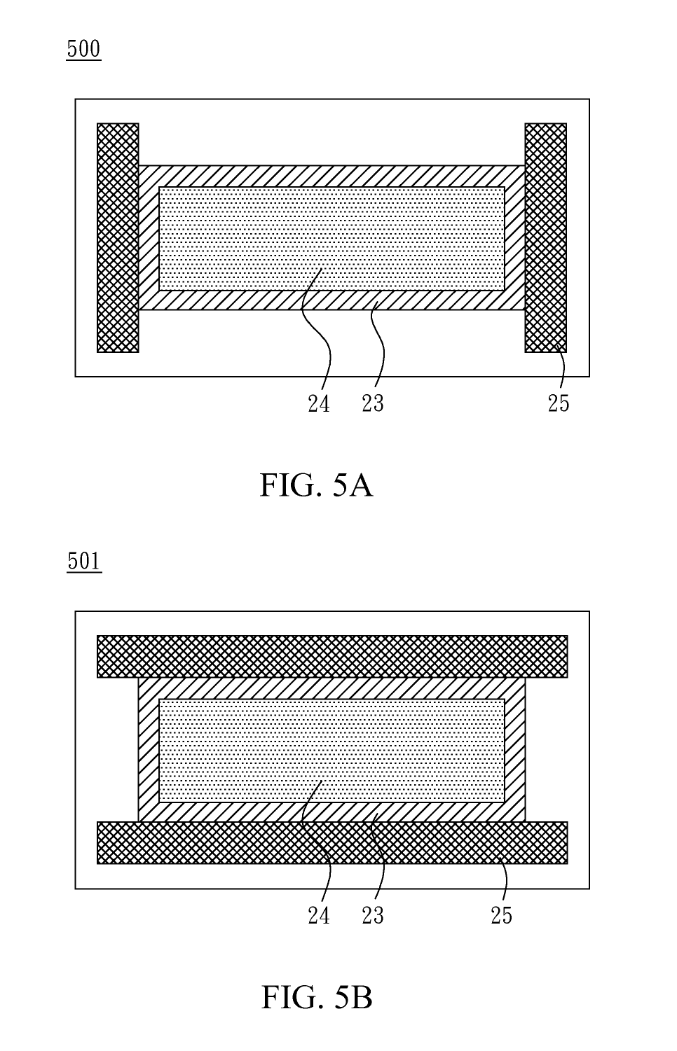

FIG. 5A shows a top view of a touch display 500 according to a third embodiment of the present invention. In the embodiment, the second sealant 25 has an open frame shape, which includes two elongated adhesives disposed around and external to two opposite sides (e.g., left side and right side) of a frame defined by the first sealant 23. FIG. 5B shows a top view of another touch display 501 according to another modified embodiment of the present invention. In the embodiment, the second sealant 25 includes two elongated adhesives disposed around and external to two opposite sides (e.g., top side and bottom side) of a frame defined by the first sealant 23. The embodiments of FIG. 5A and FIG. 5B do not exhibit a gap between the first sealant 23 and the second sealant 25. In other embodiments, however, a gap may exist between the first sealant 23 and the second sealant 25.

In a further embodiment, the second sealant 25 may include four L-shape adhesives of a type according to FIG. 4 in combination with a number (e.g., two or four) of elongated adhesives of a type according to FIG. 5A and/or FIG. 5B.

In the embodiments discussed above, double sealants (i.e., the first sealant 23 and the second sealant 25) are disposed between the display panel 21 and the touch panel 22. However, a greater number of sealants may be disposed between the display panel 21 and the touch panel 22 in other embodiments. As at least double sealants 23 and 25 are utilized in the embodiments discussed above, bonding strengths greater than those associated with conventional touch displays may be obtained while maintaining good light-transmittance. Moreover, the first sealant 23, the surface adhesive 24 and the second sealant 25 are discussed in sequence to describe the touch display embodiments 200/300/400/500/501 with an emphasis on structure rather than process or sequence.

Although specific embodiments have been illustrated and described, it will be appreciated by those skilled in the art that various modifications may be made without departing from the scope of the present invention, which is intended to be limited solely by the appended claims.

What is claimed is:

1. A touch display, comprising:
a display panel;
a touch panel disposed above the display panel;
a first sealant disposed between the display panel and the touch panel, wherein an active area is positioned between the display panel and the touch panel, and wherein the first sealant is disposed on a periphery of the active area;
a surface adhesive disposed between the display panel and the touch panel, wherein the surface adhesive is positioned in a space defined by the first sealant; and
a second sealant disposed between the display panel and the touch panel, wherein the second sealant is disposed around the space defined by the first sealant.

2. The touch display of claim 1, wherein the first sealant has a closed frame shape.

3. The touch display of claim 1, wherein a gap exists between the first sealant and the second sealant.

4. The touch display of claim 1, wherein no gap exists between the first sealant and the second sealant.

5. The touch display of claim 1, wherein one or more of the first sealant, the surface adhesive or the second sealant comprises pressure-sensitive adhesive.

6. The touch display of claim 1, wherein the second sealant has a closed frame shape.

7. The touch display of claim 1, wherein the second sealant comprises four L-shape adhesives disposed around four corners of a frame defined by the first sealant.

8. The touch display of claim 1, wherein the second sealant comprises two elongated adhesives disposed around two opposite sides of a frame defined by the first sealant.
